(19) United States
(12) Patent Application Publication
(10) Pub. No.: US 2012/0074723 A1
(43) Pub. Date: Mar. 29, 2012

(54) ASSEMBLING TOOL FOR ELECTRONIC DEVICE

(75) Inventor: BIN DAI, ShenZhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/096,298

(22) Filed: Apr. 28, 2011

(30) Foreign Application Priority Data
Sep. 23, 2010 (CN) 201010291745.X

(51) Int. Cl. B25B 9/02

(52) U.S. Cl. 294/99.2

(57) ABSTRACT

An assembly tool for mounting a component having opposite pivot holes, includes a first lever, a second lever connected to the first lever, and two positioning poles positioned on the ends of the first lever and the second lever, respectively. The levers can be operated as tweezers to place the positioning poles in the pivot holes for gripping the component.

### BACKGROUND

1. Technical Field

The present disclosure relates generally to tools and, more particularly, to an assembly tool for use in assembling components to an electronic device.

2. Description of Related Art

There are always some attached components, such as buttons, switches, indicator lights and so on, mounted on and in electronic devices. These components are often installed with their mounting portions inside the electronic devices so that the ends of screws and nuts etc. are not visible, thereby to preserve aesthetic appearance of the electronic devices. However, for very small electronic devices, it is difficult to work inside the cramped spaces to install the mounting portions.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an exploded, isometric view of a first embodiment of an assembly tool and a component to be assembled in an electronic device.

FIG. 2 is an isometric view of the assembly tool clamping the component of FIG. 1.

FIG. 3 is a partial, isometric view of the component of FIG. 1 clamped by the assembly tool being assembled in an electronic device housing.

FIG. 4 is an exploded, isometric view of the electronic device housing of FIG. 3 with the assembly tool and the component.

FIG. 5 is a top view of a second embodiment of an assembly tool.

### DETAILED DESCRIPTION

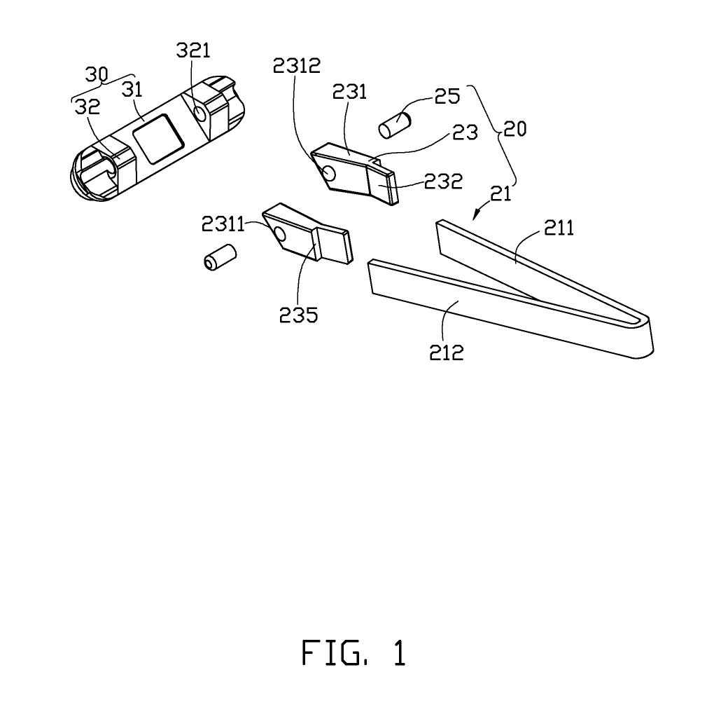

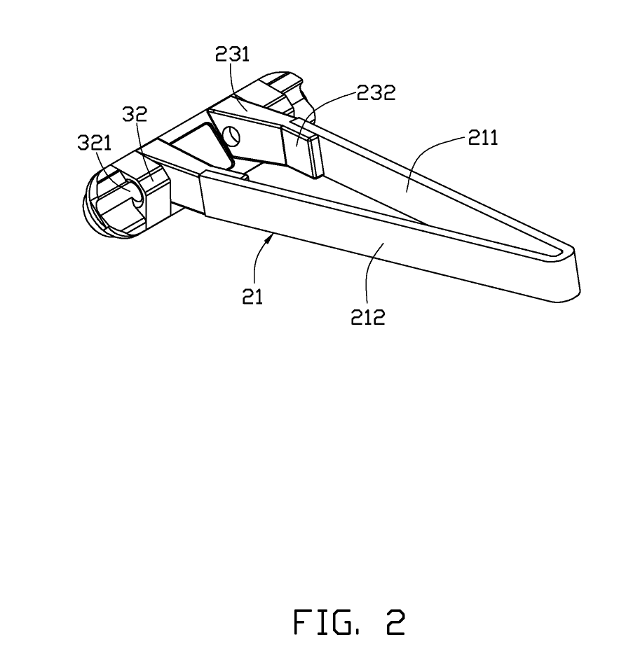

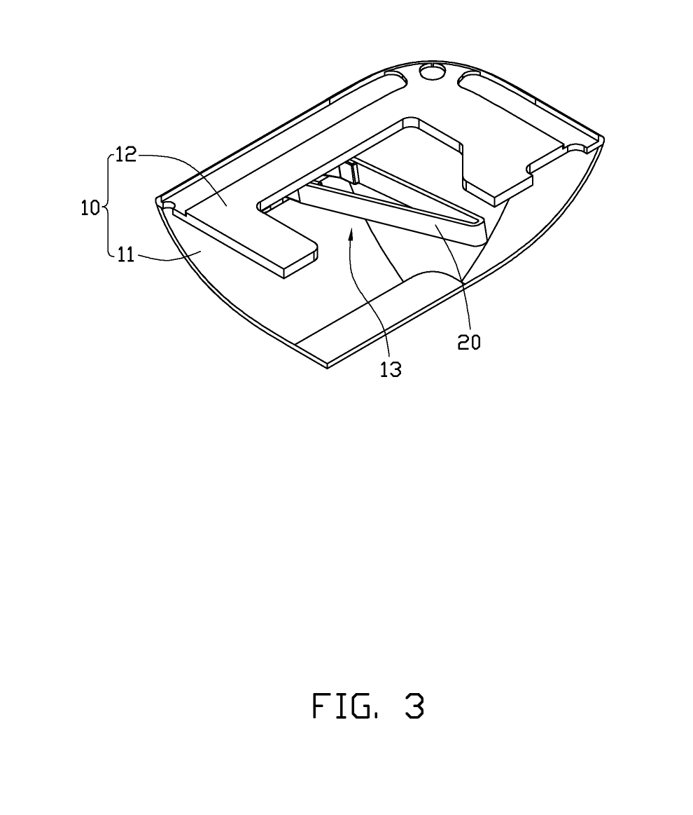

Referring to FIGS. 1 and 2, a first embodiment of an assembly tool 20 for mounting a component 30 is disclosed. The component 30 may be, for example, a key, a button, a switch, or an indicator light. In the illustrated embodiment, the component 30 is a menu button of an electronic device housing 10 (referring to FIG. 3).

The assembly tool 20 has a tweezer-like configuration with two levers joined at the fulcrums and a specially-configured gripping end as detailed in the embodiments. The assembly tool 20 includes a V-shaped clamping member 21, a pair of fixing members 23, and a pair of positioning poles 25. The V-shaped clamping member 21 includes a first lever 211 and a second lever 212 joined together to form the V-shape for the clamping member 21. The fixing members 23 are respectively fixed to the other ends of the first lever 211 and the second lever 212. The positioning poles 25 are detachably positioned on the corresponding fixing members 23. In the illustrated embodiment, the first lever 211 and the second lever 212 are the same length. The V-shaped member 21 is made of elastic materials, such as elastic plastic.

Each fixing member 23 includes an attaching portion 231 and a connecting portion 232. A stepped portion 235 is formed at a junction of the attaching portion 231 and the connecting portion 232. The first lever 211 and the second lever 212 are flexed to grasp the connecting portions 232 at the stepped portions 235. Each attaching portion 231 includes a contact surface 2311 away from the other attaching portion 231. Each contact surface 2311 defines a fixing hole 2312 for receiving the positioning pole 25.

It should be appreciated that the positioning pole 25 may be, for example, cylindrical, conical, spherical or elliptical in cross section. In the illustrated embodiment, the positioning pole 25 is cylindrical.

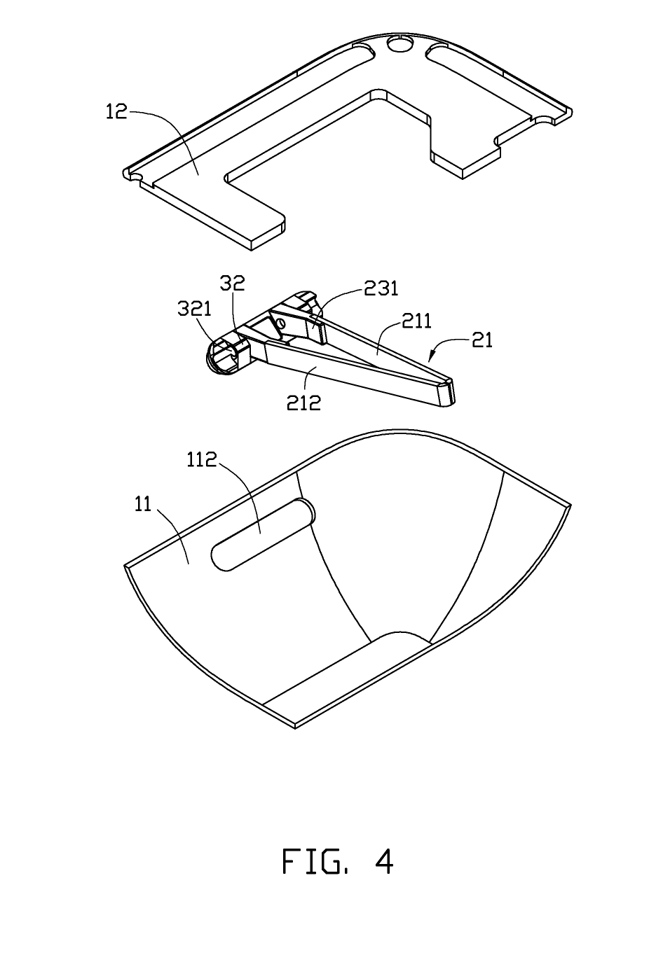

Referring to FIGS. 1, 3 and 4, the component 30 is assembled in the electronic device housing 10 using the assembly tool 20.

The housing 10 includes a top cover 11 and a bottom cover 12. The top cover 11 defines a mounting hole 112. The top cover 11 and the bottom cover 12 cooperatively define a receiving cavity 13 to receive other electronic components (not shown).

The component 30 includes a main portion 31 and two positioning portions 32 positioned on opposite sides of the main portion 31. Each positioning portion 32 defines a pivot hole 321 for receiving the positioning pole 25. The pivot holes 321 are round.

In assembling the component 30 to the housing 10, the first lever 211 and the second lever 212 are squeezed together so that the two positioning poles 25 are received in the pivot holes 321 of the component 30. The contact surface 2311 contacts the main portion 31, and then the grip on the assembly tool 20 is relaxed so that the two positioning poles 25 are received in the pivot holes 321 to engage the tool 20 in the component 30. Using the tool 20, the component 30 is mounted in the mounting hole 112. Then, the tool 20 is squeezed again to release the two positioning poles 25 from the pivot holes 321 and the tool 20 is then withdrawn.

The tool 20 is convenient to use as a gripping tool in tight spaces, and is specially-configured to easily engage with and disengage from specific components, which reduces assembly time, human error, and manufacturing costs.

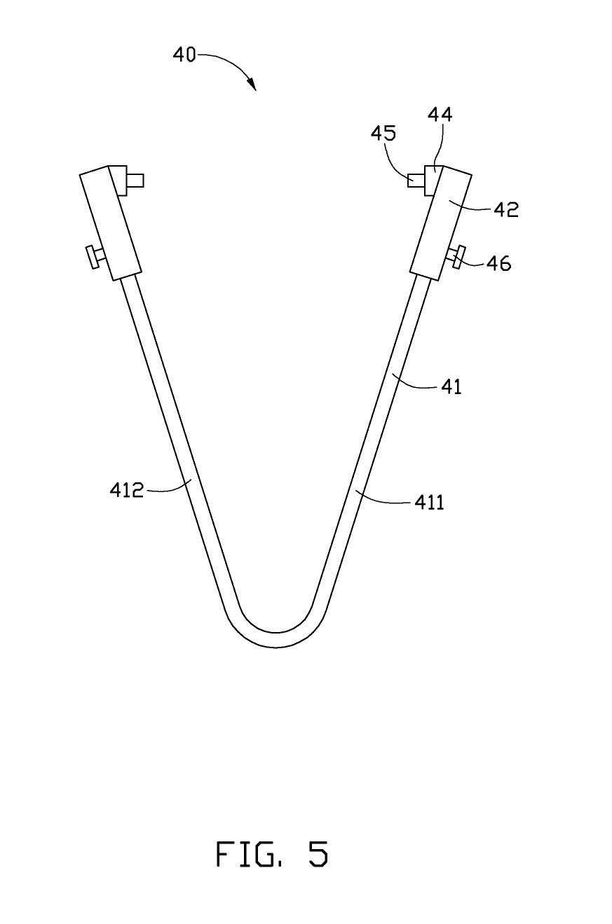

Referring to FIG. 5, a second embodiment of an assembly tool 40 differs from the assembly tool 20 only in that two sleeves 42 are respectively positioned on an end of a first lever 411 and a second lever 412 of a V-shaped clamping member 41 via a plurality of adjusting screws 46 is shown. Two positioning poles 45 are fixed on the inside surface of the two sleeves 42 via a plurality of elastic members 44, respectively. A position of the positioning poles 45 on the V-shaped clamping member 41 can be adjusted by adjusting a position of the sleeves 42. The positioning poles 45 can be received in different pivot holes of the component 30 by the elastic deformation of the elastic member 44. In the illustrated embodiment, the member 44 is made of elastic rubber, and the sleeves 42 are made of rigid plastic. The member 44 and the sleeves 42 may be connected by, for example, double-shot molding. In addition, the assembly tool 40 may also be configured as a plurality of tongs with the joining of the two arms positioned towards the gripping end of the assembly tool 40.

In alternative embodiments, if more resilience is required of the levers, a spring may be installed between the levers so they tend to be pushed apart from each other.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An assembly tool for mounting a component having a plurality of opposite pivot holes, comprising:
a first lever;
a second lever connected to the first lever; and
two positioning poles positioned on the ends of the first lever and the second lever, respectively, wherein the first lever and the second lever are squeezed together so that the positioning poles are received in the pivot holes of the component.

2. The assembly tool of claim 1, further comprising two fixing members fixed to an end of the first lever and the second lever, respectively, and the positioning poles are detachably positioned on the fixing members.

3. The assembly tool of claim 2, wherein each of the fixing members comprises an attaching portion and a connecting portion connected to the attaching portion, and the attaching portion defines a fixing hole for receiving the positioning poles.

4. The assembly tool of claim 3, wherein a stepped portion is formed at a junction of the attaching portion and the connecting portion, and the first lever and the second lever are flexed to grasp the connecting portions at the stepped portions.

5. The assembly tool of claim 1, wherein the assembly tool comprises two sleeves positioned on an end of the first lever and the second lever, respectively, and two adjusting screws for positioning the sleeves on the first lever and the second lever.

6. The assembly tool of claim 5, wherein the assembly tool comprises two elastic members positioned on the sleeves, and the positioning poles are positioned on the elastic members.

7. The assembly tool of claim 1, wherein the first lever and the second lever are joined together to form a V-shape.

8. The assembly tool of claim 1, wherein the first lever and the second lever are joined together towards a gripping end of the assembly tool.

9. The assembly tool of claim 1, wherein a spring is installed between the first lever and the second lever.
